(19) United States
(12) Patent Application Publication
(10) Pub. No.: US 2025/0006426 A1
(43) Pub. Date: Jan. 2, 2025

(54) METHOD FOR ADJUSTING THE MAGNETIZATION IN AT LEAST ONE REGION OF A SEMICONDUCTOR DEVICE

(71) Applicant: Robert Bosch GmbH, Stuttgart (DE)

(72) Inventors: Corinna Koepernik, Reutlingen (DE); Stefan Tibus, Konstanz (DE)

(21) Appl. No.: 18/698,877

(22) PCT Filed: Oct. 12, 2022
(86) PCT No.: PCT/EP2022/078348

§ 371 Date: Apr. 5, 2024

(30) Foreign Application Priority Data
Oct. 26, 2021 (DE) 10 2021 212 072.5

(51) Int. Cl. H01F 41/30

(52) U.S. Cl. CPC H01F 41/304

(57) ABSTRACT

A method for magnetizing at least one region of a semiconductor device. The method includes: heating at least one antiferromagnetic layer of the at least one region to at least a threshold temperature of the antiferromagnetic layer using a first light beam and applying a first external magnetic field in a first direction of the magnetization to be produced in a ferromagnetic layer of the at least one region at least during a cooling of the antiferromagnetic layer of the at least one region which was previously heated at least to the threshold temperature. Before heating at least the antiferromagnetic layer of the at least one region to at least the threshold temperature of the antiferromagnetic layer, at least one absorption and/or antireflection layer is disposed on and/or in at least one first subvolume of the semiconductor device which includes the at least one region.

### FIELD

The present invention relates to a method for adjusting the magnetization in at least one region of a semiconductor device. The present invention also relates to a semiconductor device.

### BACKGROUND INFORMATION

PCT Patent Application No. WO 02/082111 A1 describes a method for adjusting a magnetization in a layer arrangement comprising an antiferromagnetic layer and an adjacent ferromagnetic layer, in which at least the antiferromagnetic layer is heated to above a threshold temperature by local irradiation using a laser and, after the threshold temperature is exceeded and during a subsequent cooling of at least the antiferromagnetic layer, an applied external magnetic field can be used to produce a desired direction of magnetization in the ferromagnetic layer.

### SUMMARY

The present invention provides a method for adjusting the magnetization in at least one region of a semiconductor device and a semiconductor device.

An example embodiment of the present invention makes it possible to adjust the magnetization of a ferromagnetic layer in at least one region of a semiconductor device in that the absorption of the electromagnetic radiation of the light beam used to heat at least one antiferromagnetic layer of the at least one region is increased in a targeted manner in the at least one region by means of at least one absorption and/or antireflection layer, as a result of which unfavorable concomitant heating of at least one neighboring region of the at least one region is limited/prevented. Damage to the semiconductor device due to overheating the at least one neighboring region when carrying out the alignment of the magnetization can thus be avoided, while at least the antiferromagnetic layer of the at least one region can nonetheless be reliably heated to at least its threshold temperature.

As will become evident from the following description, the present invention can also be used to configure any number of different magnetization directions (pinning directions) in the respective regions of the semiconductor device provided for this purpose. The thus realized magnetization directions can then be used as sensing directions. The present invention can thus also be used to produce a semiconductor device that is used as a sensor device. With appropriate interconnection, the combination of different sensing directions in a semiconductor component can be used to form a 2D-Sensor (independent sensing in x and y direction) or, possibly after integration of a suitable flux diverter, to form a 3D-Sensor (x, y and z). Due to its unlimited number of sensing directions, the thus obtained sensor device has a comparatively high sensitivity and reliable resistance to interference fields. The sensing directions can specifically also include pairwise opposite sensing directions. Because of its unlimited number of sensing directions, such a sensor device can in particular also be configured for 360° angle sensing. A sensor device created by means of the present invention can, for instance, be used to realize a tunneling magnetoresistance (TMR) sensor or a giant magnetoresistance (GMR) sensor.

According to an example embodiment of the present invention, the at least one absorption and/or antireflection layer is preferably disposed on and/or in at least the first subvolume of the semiconductor device such that absorption of the first light beam in at least the part of the at least one region is increased by means of the at least one absorption and/or antireflection layer. This achieves a targeted increase in the absorption and/or heat conduction of the energy of the first light beam at/to the antiferromagnetic layer of the at least one region, and thus brings about a targeted heating of the antiferromagnetic layer of the at least one region to at least its threshold temperature while avoiding/limiting undesired concomitant heating of the at least one neighboring region of the at least one region.

According to an example embodiment of the present invention, during the heating of at least the antiferromagnetic layer of the at least one region to at least the threshold temperature of the antiferromagnetic layer using the first light beam, the first light beam is preferably aligned such that the first light beam hits a surface of at least the first subvolume of the semiconductor device which comprises the at least one region or at least one outer layer which covers the surface, and where at least a first partial area of the surface is covered with the at least one absorption and/or antireflection layer while at least a second partial area of the surface is kept free of or not covered by the at least one absorption and/or antireflection layer. The here-described embodiment of the method achieves a targeted increase in the absorption of the electromagnetic radiation of the first light beam in the at least one region while at the same time avoiding/limiting undesired concomitant heating of at least one neighboring region adjoining the at least one second partial area of the surface.

As an advantageous further development of the method of the present invention, in which, during the heating of at least the antiferromagnetic layer of the at least one region to at least the threshold temperature of the antiferromagnetic layer using the first light beam, the first light beam is aligned such that the first light beam hits the surface of the first subvolume of the semiconductor device which comprises the at least one region or the at least one outer layer which covers the surface, while the first light beam is dimmed or suppressed on a second subvolume of the semiconductor device by beam shaping the first light beam, the following method steps can be carried out after the first external magnetic field has been applied: heating at least one antiferromagnetic layer of at least one further region in the second subvolume of the semiconductor device to at least a threshold temperature of the antiferromagnetic layer of the at least one further region using a second light beam such that at least one subbeam of the second light beam is absorbed by at least a part of the at least one further region and converted into heat, as a result of which at least the antiferromagnetic layer of the at least one further region is heated, while the second light beam is dimmed or surpressed on the first subvolume of the semiconductor device by beam shaping the second light beam, and applying a second external magnetic field in a second direction different from the first direction at least during a cooling of the antiferromagnetic layer of the at least one further region which was previously heated at least to the threshold temperature, as a result of which a ferromagnetic layer of the at least one further region is magnetized. As will become evident from the following description, the here-described further development of the method can be used to achieve any number of different magnetization directions (pinning directions) in the respective regions of the semiconductor device.

According to an example embodiment of the present invention, a silicon nitride layer, a layer combination of at least one silicon nitride layer and at least one silicon oxide layer (36b), a titanium nitride layer, a titanium tungsten nitride layer, a tantalum layer, a tantalum nitride layer and/or a tungsten layer can be arranged on and/or in at least the first subvolume of the semiconductor device as the at least one absorption and/or antireflection layer, for instance. It is thus possible to use a variety of materials frequently already used in semiconductor technology for the at least one absorption and/or antireflection layer. As will further be evident from the following description, the at least one absorption and/or antireflection layer can also be used for other purposes after magnetization has been carried out using the method described here. It should also be noted that the examples for the at least one absorption and/or antireflection layer described here are not to be interpreted as exhaustive.

In particular, according to an example embodiment of the present invention, at least one dielectric antireflection layer can be disposed on and/or in at least the first subvolume of the semiconductor device as the at least one absorption and/or antireflection layer. The at least one dielectric antireflection layer ensures a desired increase in the absorption of electromagnetic radiation specifically in the at least one respective region to be heated.

According to an example embodiment of the present invention, the above-described advantages are also ensured with a semiconductor device having at least one region comprising a respective antiferromagnetic layer and a ferromagnetic layer with a magnetization of the ferromagnetic layer, wherein the semiconductor device comprises at least one absorption and/or antireflection layer on and/or in at least one subvolume of the semiconductor device which comprises the at least one region.

Preferably, according to an example embodiment of the present invention, at least a first partial area of a surface of at least the subvolume of the semiconductor device which comprises the at least one region is covered with the at least one absorption and/or antireflection layer while at least a second partial area of the surface is not covered by the at least one absorption and/or antireflection layer.

According to an example embodiment of the present invention, the at least one absorption and/or antireflection layer can include a silicon nitride layer, a layer combination of at least one silicon nitride layer and at least one silicon oxide layer, a titanium nitride layer, a titanium tungsten nitride layer, a tantalum layer, a tantalum nitride layer and/or a tungsten layer, for instance. Alternatively or additionally, the at least one absorption and/or antireflection layer can also include at least one dielectric antireflection layer.

### BRIEF DESCRIPTION OF THE DRAWINGS

Further features and advantages of the present invention are explained in the following with reference to the figures.

FIGS. 1A-1C show a flow chart and schematic illustrations to explain a first embodiment of the method of the present invention for adjusting the magnetization in at least one region of a semiconductor device.

FIG. 2 shows a schematic illustration to explain a second embodiment of the method of the present invention for adjusting the magnetization in at least one region of a semiconductor device.

FIG. 3 shows a schematic illustration to explain a third embodiment of the method of the present invention for adjusting the magnetization in at least one region of a semiconductor device.

FIG. 4 shows a schematic illustration to explain a fourth embodiment of the method of the present invention for adjusting the magnetization in at least one region of a semiconductor device.

FIG. 5 shows a schematic illustration to explain a fifth embodiment of the method of the present invention for adjusting the magnetization in at least one region of a semiconductor device.

FIGS. 6A and 6B show a flow chart and a schematic illustration to explain a sixth embodiment of the method of the present invention for adjusting the magnetization in at least one region of a semiconductor device.

### DETAILED DESCRIPTION OF EXAMPLE EMBODIMENTS

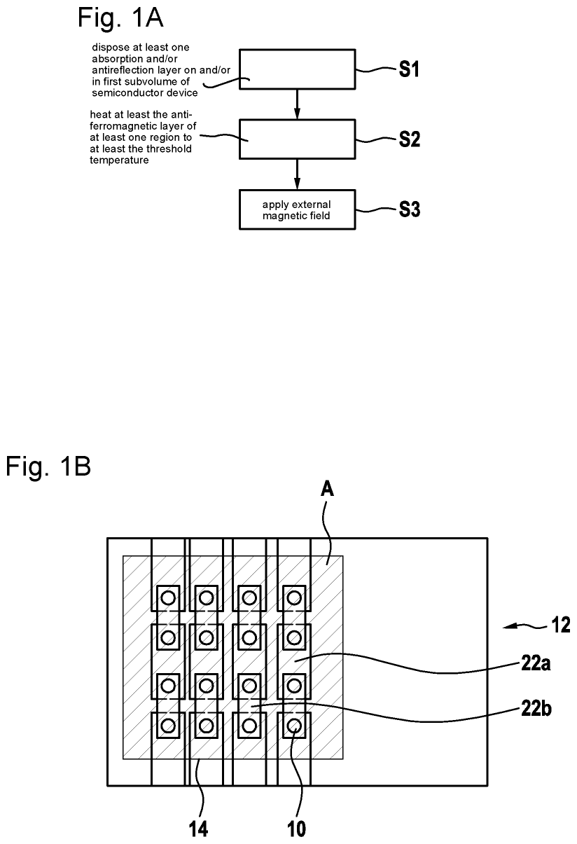

FIGS. 1A-1C show a flow chart and schematic illustrations to explain a first embodiment of the method for adjusting the magnetization in at least one region of a semiconductor device. When carrying out the method described in the following, which is shown in FIG. 1A as a flow chart, at least one region 10 of a semiconductor device 12 is magnetized, wherein the at least one region 10 of the semiconductor device 12 comprises a respective antiferromagnetic layer 10a and a ferromagnetic layer 10b. Even though this is not shown in FIGS. 1B and 1C, the antiferromagnetic layer 10a and the ferromagnetic layer 10b are disposed relative to one another such that, at least at a temperature of the antiferromagnetic layer 10a and the ferromagnetic layer 10b below a (later discussed) threshold temperature, a so-called “exchange bias effect” occurs, which brings about the magnetization of the ferromagnetic layer 10b to align according to the magnetization at the boundary surface of the antiferromagnetic layer 10a. An outer surface of the antiferromagnetic layer 10a can be in mechanical contact with an outer surface of the ferromagnetic layer 10b, for example. Alternatively, however, there may also be at least one intermediate layer between the antiferromagnetic layer 10a and the ferromagnetic layer 10b.

The antiferromagnetic layer 10a is at least partly (preferably completely) made of at least one antiferromagnetic material, such as nickel oxide, iridium manganese (IrMn) and/or platinum manganese (PtMn). However, the examples listed here for the at least one antiferromagnetic material are not to be interpreted as exhaustive. The ferromagnetic layer 10b correspondingly preferably comprises at least one ferromagnetic material or hard magnetic material. Specifically, the ferromagnetic layer 10b can include cobalt, iron, nickel, platinum, palladium, and/or boron (B). The antiferromagnetic layer 10a and/or the ferromagnetic layer 10b can each also be a layer stack. The ferromagnetic layer 10b can be a layer stack consisting of at least two hard magnetic layers with a respective a non-magnetic layer between two adjacent hard magnetic layers, for instance. The at least one non-magnetic layer of the layer stack can include ruthenium (Ru), for example.

The alignment of the magnetization of the ferromagnetic layer 10b according to the magnetization at the boundary surface of the antiferromagnetic layer 10a brought about by the exchange bias effect can also be referred to as a “pinning” of the ferromagnetic layer 10b. The threshold temperature is the temperature at/above which the antiferromagnetic material loses its ability to “pin” the ferromagnetic layer 10b. The threshold temperature is therefore often also referred to as a blocking temperature. The threshold temperature depends on the at least one antiferromagnetic material of the antiferromagnetic layer 10a and is therefore referred to in the following as the threshold temperature of the antiferromagnetic layer 10a.

The magnetization of the at least one region 10 of the semiconductor device 12 brought about with the method described here is to be understood as an alignment of the direction of the magnetization/magnetization direction of the ferromagnetic layer 10b, in particular in accordance with a given target magnetization direction. To achieve the desired magnetization of the ferromagnetic layer 10b of the at least one region 10, it is advantageous to “cancel” the exchange bias effect by briefly heating at least the antiferromagnetic layer 10a of the at least one region 10 to at least the threshold temperature of the antiferromagnetic layer 10a.

Using the method described in the following, the antiferromagnetic layer 10a of the at least one region 10 can be specifically heated to at least the threshold temperature of the antiferromagnetic layer 10a by means of a light beam 14:

For this purpose, a method step S1 is carried out before the antiferromagnetic layer 10a of the at least one region 10 is heated to at least the threshold temperature of the antiferromagnetic layer 10a by means of a light beam 14. In the method step S1, at least one absorption and/or antireflection layer 16 is disposed on and/or in at least a first subvolume 12a of the semiconductor device 12. As can be seen in FIG. 1C (sectional view), the first subvolume 12a of the semiconductor device 12 incudes the at least one region 10. Advantageous examples of the at least one absorption and/or antireflection layer 16 will be discussed below.

In a method step S2 carried out after the method step S1, at least the antiferromagnetic layer 10a of the at least one region 10 is heated to at least the threshold temperature of the antiferromagnetic layer 10a. For this purpose, the light beam 14 is directed onto the semiconductor device 12 such that at least one subbeam of the first light beam 14 is absorbed by at least a part of the at least one region 10 and converted into heat, as a result of which at least the antiferromagnetic layer 10a is heated.

The at least one absorption and/or antireflection layer 16 brings about an increased absorption of electromagnetic radiation of the light beam 14 by at least a part of the at least one region 10 during the execution of the method step S2 and, due to heat conduction, also a heating of the antiferromagnetic layer 10a of the at least one region 10. In other words, the at least one absorption and/or antireflection layer 16 brings about increased absorption by the at least one region 10 or an increase in the absorbance of the at least one region 10. The at least one absorption and/or antireflection layer 16 thus also affects a temperature distribution in a light incidence region A of the light beam 14 such that, above all, a local temperature of the antiferromagnetic layer 10a of the at least one region 10 reaches or exceeds the threshold temperature, while at least one neighboring region 18 adjacent to the at least region 10 is heated less than or at least not more than the antiferromagnetic layer 10a of the at least one region 10 despite its position in the light incidence region A of the light beam 14.

This achieves a targeted heating of the antiferromagnetic layer 10a of the at least one region 10 to at least its threshold temperature while avoiding/limiting concomitant heating of the at least one neighboring region 18. Avoiding/limiting concomitant heating of the at least one neighboring region 18 makes it possible to prevent damage to the semiconductor device 12 resulting from overheating of the at least one neighboring region 18. The achieved avoiding/limiting of the concomitant heating of the at least one neighboring region 18 also makes it possible to prevent heat transfer from the respective neighboring region 18 to a surrounding region of the semiconductor device 12. The advantages of prevented heat transfer will be discussed below.

In a further method step S3, an external magnetic field is applied, the direction of which determines the magnetization (i.e. its magnetization direction) to be effected in the ferromagnetic layer 10b of the at least one region 10. The method step S3 takes place at least during a cooling of the antiferromagnetic layer 10a of the at least one region 10 which was previously heated at least to the threshold temperature. The method step S3 can, of course, also be carried out when at least the threshold temperature has already been reached at least at the antiferromagnetic layer 10a of the at least one region 10. The application of the external magnetic field can conveniently also be started prior to starting method step S2, because the heating of at least the antiferromagnetic layer 10a of the at least one region 10 at least to the threshold temperature typically takes only one or a few laser pulse lengths of a few nanoseconds, for example.

Advantageous ways of carrying out the here-described method are discussed in the following:

The light beam 14 used to carry out method step S2 can be aligned to the semiconductor device 12 with the aid of a mask, for example. The method step S2 can alternatively also be carried out using a light beam 14 with a comparatively small beam diameter, which either sweeps over the surface 14 or scans it in successive pulses. The light beam 14 can be either a pulsed or a continuous light beam 14. The light source emitting the light beam 14 can be a laser, for instance. The light incidence region A of the light beam 14 on the semiconductor device 12 can have a maximum extent of between 5 μm (microns) and 200 μm (microns), for example.

As can be seen in FIG. 1C, in the embodiment of the method described here, the light beam 14 is aligned during method step S2 such that the light beam 14 hits a surface S of at least the first subvolume 12a. In order to bring about the desired targeted heating of the antiferromagnetic layer 10a of the at least one region 10 to at least the threshold temperature by means of the light beam 14, at least a first partial area 20a of the surface S is covered with the at least one absorption and/or antireflection layer 16 during execution of the method step S1, while at least a second partial area 20b of the surface S is kept free of or not covered by the at least one absorption and/or antireflection layer 16. Because a desired position and a desired shape of the at least one absorption and/or antireflection layer 16 can be maintained with greater precision than the light beam 14 can be limited to a desired maximum light incidence area on the surface S, the here-described configuration of the at least one absorption and/or antireflection layer 16 while keeping free/not covering the at least one second partial surface 20b of the surface S makes it possible to achieve an even more targeted heating of the antiferromagnetic layer 10a of the at least one region 10 to at least the threshold temperature while avoiding/preventing concomitant heating of the at least one neighboring region 18. In FIG. 1C, it can be seen that the light incidence region A of the light beam 14 on the surface S can easily also cover neighboring regions 18 adjacent to the at least one region 10 without undesirable overheating of said neighboring regions.

In the embodiment of the method described here, as an example, the semiconductor device 12 comprises a plurality of top electrodes 22a and a plurality of bottom electrodes 22b, and the regions 10 to be magnetized all lie between a respective top electrode 22a and a respective bottom electrode 22b. The top electrodes 22a and the bottom electrodes 22b are each made of at least one metal, in particular tantalum, ruthenium, tantalum nitride and/or copper. However, the materials for the electrodes 22a and 22b listed here are to be interpreted merely as examples. The top electrodes 22a and the bottom electrodes 22b are furthermore embedded in an insulating layer 24 such that the individual areas 10 to be magnetized are properly interconnected. The insulating layer 24 is made of silicon dioxide and/or silicon oxide, for example.

When designed as a tunnel magnetic sensor, a tunnel barrier and a soft magnetic layer are disposed between the top electrodes 22a or the bottom electrodes 22b and the ferromagnetic layer 10b as well. The tunnel barrier can be a very thin magnesium oxide or aluminum oxide layer, for instance. The soft magnetic layer substantially aligns its magnetization to the external magnetic field. The resistance of the tunnel barrier changes with the angle between the magnetization direction of the adjoining hard and soft magnetic layers. The sensing direction is the fixed magnetization direction of the ferromagnetic layer 10a adjoining the tunnel barrier which was defined by the pinning process. The change in the resistance of the tunnel barrier can be detected by means of a current flow through the layer system and can be used as a sensor signal.

Advantageously, the only absorption and/or antireflection layer 16 of the embodiments of FIGS. 1A to 1C is a silicon nitride layer. Because the surface S hit by the light beam 14 during the execution of the method step S2 consists of the silicon dioxide of the insulating layer 24 and the metal of the top electrodes 22a, the silicon nitride-metal boundary surfaces 28 between the top electrodes 22a and the absorption and/or antireflection layer 16 lead to an increase in the absorption of electromagnetic radiation of the light beam 14 and increased heat conduction in the regions 10. Unlike the silicon nitride-metal boundary surfaces 28, this effect does not occur on the at least one second partial area 20b of the surface S not covered by the absorption and/or antireflection layer 16. At the at least one silicon nitride-silicon dioxide boundary surface 30 between the insulating layer 24 and the absorption and/or antireflection layer 16, the layer thicknesses of the layers 16 and d1 can be optimized such that the light radiation absorbed by the bottom electrode approximates the light radiation absorbed in the regions 28. The thus generated heat energy can then contribute to the heating of the regions 10 through heat conduction via the bottom electrode. The silicon nitride-metal boundary surfaces 28 created by the absorption and/or antireflection layer 16 thus selectively increase the absorption of the regions 10 while limiting the absorption of the at least one neighboring region 18. The absorption and/or antireflection layer 16 made of silicon nitride can moreover remain in use after the here-described method is carried out as a dielectric passivation layer.

Local layer thicknesses d1 and d2 of the insulating layer 24 aligned perpendicular to the light incidence region A of the light beam 14 on the surface S can additionally also be used during the execution of the method step S2 to bring about a desired temperature distribution. The extent of the layer 16 and the local layer thickness d1 or d2 of the insulating layer 24 can in particular be selected such that either outer regions of the antiferromagnetic layer 10a of the at least one region 10 are also reliably heated to at least the threshold temperature, or that absorption is reduced in these regions.

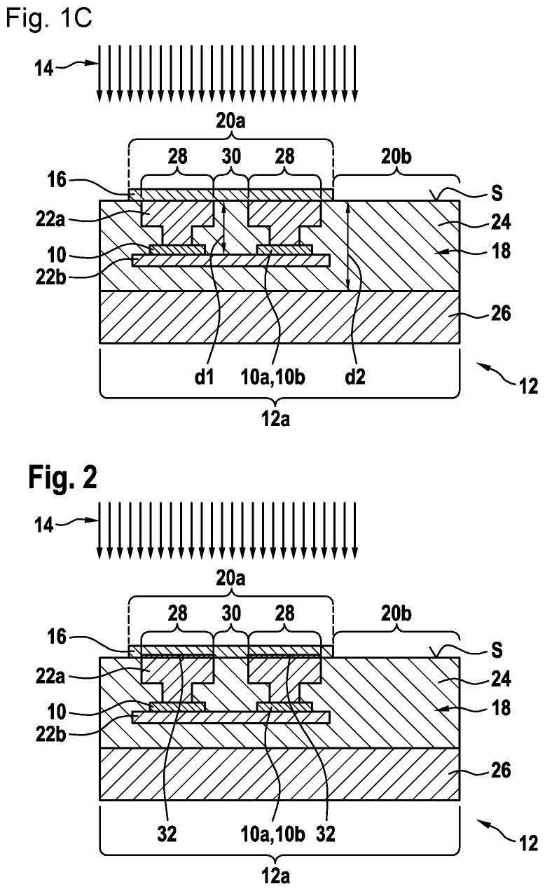

FIG. 2 shows a schematic illustration to explain a second embodiment of the method for adjusting the magnetization in at least one region of a semiconductor device.

In the method shown schematically by FIG. 2, a metal layer or metallic connecting layer 32 is disposed on and/or in at least the first subvolume 12a of the semiconductor device 12 as the at least one absorption and/or antireflection layer 16 and 32 in addition to the silicon nitride layer 16. The metal layer 32 can, for example, be a titanium nitride layer, a titanium tungsten nitride layer, a tantalum layer, a tantalum nitride layer, a tungsten layer, and/or some other layer that has an absorbing effect in the used wavelength range of the used radiation 14. The metal layer 32 can be 50 to 100 nm (nanometers) thick, for instance.

As an example, in the embodiment described here, the metal layer 32 lies between the surface S and the silicon nitride layer 16 and covers the top electrodes 22a, wherein shapes of cover surfaces structured out of the metal layer 32 correspond (not necessarily identically) to a respective cross-section of the top electrode 22a covered with it within the surface S. The additional use of the metal layer 32 makes it possible to increase the absorption of electromagnetic radiation of the light beam 14 at the silicon nitride-metal boundary surfaces 28 even more, while limiting the absorption of the at least one neighboring region 18.

With regard to the further method steps of the method of FIG. 2 and their advantages, reference is made to the description of FIGS. 1A to 1C.

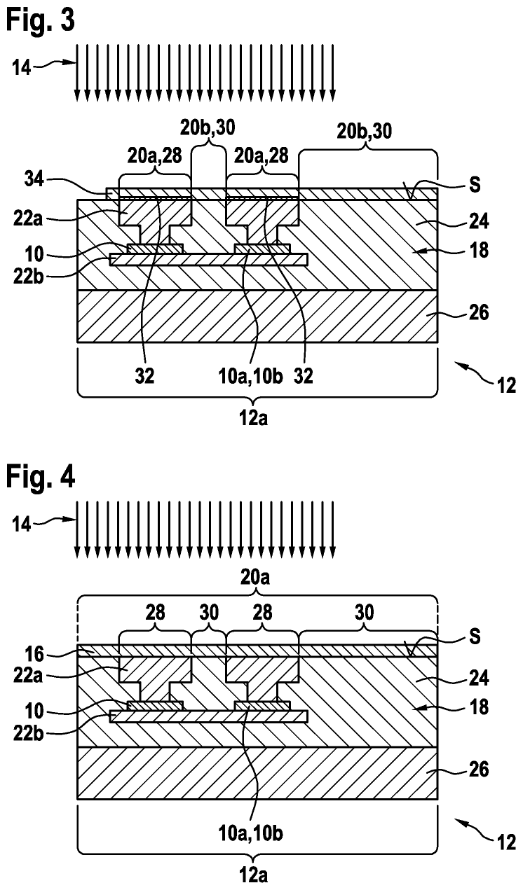

FIG. 3 shows a schematic illustration to explain a third embodiment of the method for adjusting the magnetization in at least one region of a semiconductor device.

In the embodiment of FIG. 3, the light beam 14 for heating at least the antiferromagnetic layer 10a of the at least one region 10 to at least the threshold temperature is aligned such that the light beam 14 hits at least one outer layer 34 covering the surface S. The outer layer 34 is a silicon nitride layer, for example, with which the at least one absorption and/or antireflection layer 32 formed on the surface S is covered.

The (only) absorption and/or antireflection layer 32 is a metal layer or metal connecting layer 32, such as a titanium nitride layer, a titanium tungsten nitride layer, a tantalum layer, a tantalum nitride layer, a tungsten layer, and/or some other layer that has an absorbing effect in the used wavelength range of the used radiation 14. Cover surfaces structured out of the metal layer 32 moreover cover only the top electrodes 22a, in that a respective shape of the cover surfaces corresponds to a respective cross-section of the top electrode 22a covered with it within the surface S. In the embodiment of FIG. 3, too, the absorption of electromagnetic radiation of the light beam 14 at the silicon nitride-metal boundary surfaces 28 is increased while limiting the absorption of the at least one neighboring region 18.

With regard to the further method steps of the method of FIG. 3 and its advantages, reference is made to the description of FIGS. 1A-1C and 2.

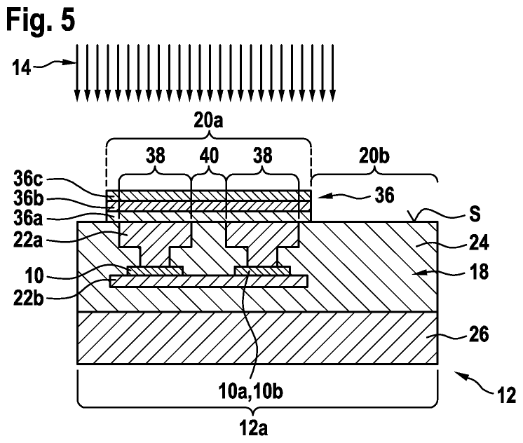

FIG. 4 shows a schematic illustration to explain a fourth embodiment of the method for adjusting the magnetization in at least one region of a semiconductor device.

The method of FIG. 4 differs from the embodiment of FIGS. 1A-1C only in that the at least one second partial area 20b of the surface S is not kept free of and/or uncovered by the at least one absorption and/or antireflection layer 16 during execution of the method discussed here. However, as can be seen in FIG. 4, the absorption and/or antireflection layer 16 made of silicon nitride brings about an increase in the absorption and/or the heat conduction of the energy of the light beam 14 at/to the antiferromagnetic layer 10a of the at least one region 10 in the method discussed here, too (compared with the at least one silicon nitride-silicon dioxide boundary surface 30 between the insulating layer 24 and the absorption and/or antireflection layer 16). In this embodiment, the thicknesses of the dielectric layers can be coordinated with one another and to the wavelength of the used radiation 14 such that the absorption of the radiation is advantageously greater in the regions 10 than in the adjoining regions.

With regard to the further method steps of the method of FIG. 4 and their advantages, reference is made to the description of FIGS. 1A to 3.

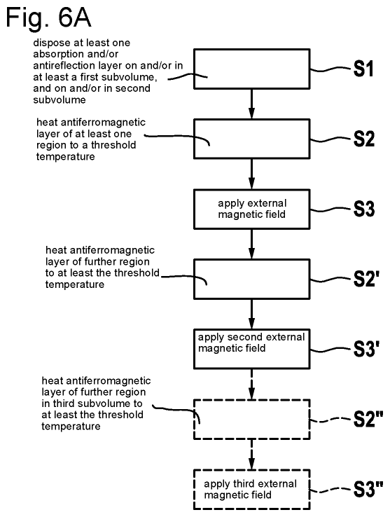

FIG. 5 shows a schematic illustration to explain a fifth embodiment of the method for adjusting the magnetization in at least one region of a semiconductor device.

In the embodiment shown schematically by FIG. 5, at least one dielectric antireflection layer 36 is disposed on and/or in at least the first subvolume 12a of the semiconductor device 12 as the at least one absorption and/or antireflection layer 36. Merely as an example, in the embodiment described here, the at least one dielectric antireflection layer 36 comprises a first silicon nitride layer 36a which covers the at least one first partial area 20a of the surface S, a silicon dioxide layer 36b which covers the first silicon nitride layer 36a and a second silicon nitride layer 36c which covers the silicon dioxide layer 36b. Other dielectric layers with different refractive indices can also be used instead of the silicon nitride and silicon oxide layers.

With regard to the further method steps of the method of FIG. 5, and their advantages, reference is made to the description of FIGS. 1A-1C to 4.

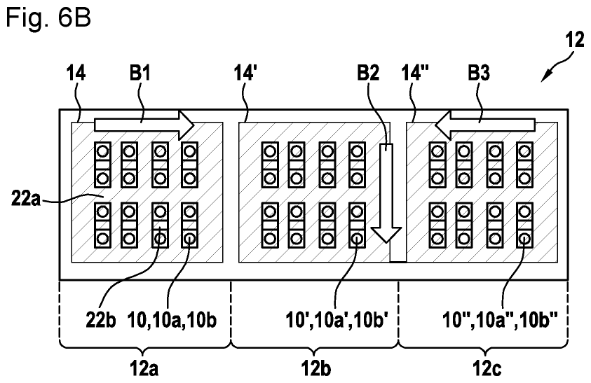

FIGS. 6A and 6B show a flow chart and a schematic illustration to explain a sixth embodiment of the method for adjusting the magnetization in at least one region of a semiconductor device.

In the method shown schematically by FIGS. 6A and 6B, the method step S1 is carried out first, wherein the at least one absorption and/or antireflection layer 16, 32 and/or 36 is disposed not only on and/or in at least the first subvolume 12a, but also on and/or in a second subvolume 12b and a third subvolume 12c of the semiconductor device 12. Next, the method step S2 is carried out, wherein, during the heating of at least the antiferromagnetic layer 10a of the at least one region 10 to at least the threshold temperature of the antiferromagnetic layer 10a using the first light beam 14, the first light beam 14 is aligned such that the first light beam 14 hits the surface S of the first subvolume 12a which comprises the at least one region 10 or the at least one outer layer 34 which covers the surface S, while the first light beam 14 is dimmed by the second subvolume 12b and the third subvolume 12c by beam shaping the first light beam 14.

After the application of the first external magnetic field B1 in method step S3, further method steps are carried out:

In a method step S2′, at least one antiferromagnetic layer 10a′ of at least one further region 10′ in the second subvolume 12b is heated to at least a threshold temperature of the antiferromagnetic layer 10a′ of the at least one further region 10′ by means of a second light beam 14′ in that at least one subbeam of the second light beam 14′ is absorbed by at least a part of the at least one further region 10′ and converted into heat, so that at least the antiferromagnetic layer 10a′ of the at least one further region 10′ is heated, while the second light beam 14′ is dimmed or suppressed on the first subvolume 12a and the third subvolume 12c by beam shaping the second light beam 14′. In addition, as method step S3′, a second external magnetic field B2 is applied in a second direction different from the first direction, at least during a cooling of the antiferromagnetic layer 10a′ of the at least one further region 10′ which was previously heated at least to the threshold temperature, as a result of which a ferromagnetic layer 10b′ of the at least one further region 10′ is magnetized and fixed (pinned) in this magnetization direction during the cooling process of the antiferromagnetic layer.

Optionally, in a method step S2″, at least one antiferromagnetic layer 10a″ of at least one further region 10″ in the third subvolume 12c can then be heated by means of a third light beam 14″ to at least a threshold temperature of the antiferromagnetic layer 10a″ of the third subvolume 12c. As a method step S3″, at least during cooling of the antiferromagnetic layer 10a″ of the third subvolume 12c which was previously heated at least to the threshold temperature, a ferromagnetic layer 10b″ of the at least one further region 10″ can be magnetized by means of a third external magnetic field B3 in a third direction different from the first direction and the second direction. The advantageous magnetization of the regions 10, 10′ and 10″ in different directions is possible because of the advantageous avoidance/limitation of concomitant heating of at least one neighboring region 18 and the thus prevented heat transfer from the respective neighboring region 18 despite the relatively close proximity of the regions 10, 10′ and 10″.

Steps S2 and S3 can be repeated as often as necessary in different regions 10 with different or the same magnetic directions.

With regard to the further method steps of the method of FIGS. 6A and 6B, and their advantages, reference is made to the description of FIGS. 1A to 5.

The methods discussed above can also be referred to as pinning processes. They can be carried out at the end of the production of the respective semiconductor devices 12, for instance. Compliance with special protective measures, such as carrying out the respective procedure in a clean room, is not necessary. Each one of the above-described methods can alternatively also be carried out during the production of the respective semiconductor device 12. In that case, the pinning process can be followed by further steps for interconnecting and contacting the sensor regions and/or to implement further functions.

FIGS. 1A to 6B each also show a semiconductor device 12 with at least one region 10 comprising a respective antiferromagnetic layer 10a and a ferromagnetic layer 10b with a magnetization of the ferromagnetic layer 10b. The semiconductor device 12 additionally also comprises at least one absorption and/or antireflection layer 16, 32 and/or 36 on and/or in at least one subvolume 12a of the semiconductor device 12 which comprises the at least region 10. At least a first partial area 20a of a surface S of at least the subvolume 12a of the semiconductor device 12 which comprises the at least one region 10 can be covered with the at least one absorption and/or antireflection layer 16, 32 and/or 36, for example, while at least a second partial area 20b of the surface S is not covered by the at least one absorption and/or antireflection layer 16, 32 and/or 36. Examples of the at least one absorption and/or antireflection layer 16, 32, and/or 36 have already mentioned above. Each of the semiconductor devices 12 shown in FIG. 1A to 6B can advantageously be used as a sensor device. The at least one sensor device of the respective semiconductor device/sensor device 12 is defined by the at least one magnetization direction of the regions 10, 10′, 10″ and possible further regions 10^{x} of the respective sensor device 12. The regions 10, 10′ and 10″ and possible further regions 10^{x} can be interconnected to form at least one Wheatstone bridge, for instance. The respective semiconductor device/sensor device 12 can, for example, be a tunneling magnetoresistance (TMR) sensor or a giant magnetoresistance (GMR) sensor.

1-10. (canceled)

11. A method for adjusting the magnetization in at least one region of a semiconductor device, comprising the following steps:
heating at least one antiferromagnetic layer of the at least one region to at least a threshold temperature of the antiferromagnetic layer using a first light beam such that at least one subbeam of the first light beam is absorbed by at least a part of the at least one region and converted into heat, as a result of which at least the antiferromagnetic layer is heated;
applying a first external magnetic field in a first direction of the magnetization to be produced in a ferromagnetic layer of the at least one region at least during a cooling of the antiferromagnetic layer of the at least one region which was previously heated at least to the threshold temperature; and
before the heating of at least the antiferromagnetic layer of the at least one region to at least the threshold temperature of the antiferromagnetic layer using the first light beam, disposing at least one absorption and/or antireflection layer on and/or in at least one first subvolume of the semiconductor device which includes the at least one region.

12. The method according to claim 11, wherein the at least one absorption and/or antireflection layer is disposed on and/or in at least the first subvolume of the semiconductor device such that absorption of the first light beam in at least the part of the at least one region is increased using the at least one absorption and/or antireflection layer.

13. The method according to claim 11, wherein, during the heating of at least the antiferromagnetic layer of the at least one region to at least the threshold temperature of the antiferromagnetic layer using the first light beam, the first light beam is aligned such that the first light beam hits a surface of at least the first subvolume of the semiconductor device which includes the at least one region or at least one outer layer which covers the surface, and wherein at least a first partial area of the surface is covered with the at least one absorption and/or antireflection layer while at least a second partial area of the surface is kept free of or not covered by the at least one absorption and/or antireflection layer.

14. The method according to claim 11, wherein during the heating of at least the antiferromagnetic layer of the at least one region to at least the threshold temperature of the antiferromagnetic layer using the first light beam, the first light beam is aligned such that the first light beam hits a surface of the first subvolume of the semiconductor device which includes the at least one region or at least one outer layer which covers the surface, while the first light beam is dimmed by a second subvolume of the semiconductor device by beam shaping the first light beam, and wherein, after the first external magnetic field has been applied, the following method steps are carried out:
heating at least one antiferromagnetic layer of at least one further region in the second subvolume of the semiconductor device to at least a threshold temperature of the antiferromagnetic layer of the at least one further region using a second light beam such that at least one subbeam of the second light beam is absorbed by at least a part of the at least one further region and converted into heat, as a result of which at least the antiferromagnetic layer of the at least one further region is heated, while the second light beam is dimmed by the first subvolume of the semiconductor device by beam shaping the second light beam; and
applying a second external magnetic field in a second direction different from the first direction at least during a cooling of the antiferromagnetic layer of the at least one further region which was previously heated at least to the threshold temperature, as a result of which a ferromagnetic layer of the at least one further region is magnetized.

15. The method according to claim 11, wherein a silicon nitride layer, and/or a layer combination of at least one silicon nitride layer and at least one silicon oxide layer, and/or a titanium nitride layer, and/or a titanium tungsten nitride layer, and/or a tantalum layer, and/or a tantalum nitride layer, and/or a tungsten layer, is disposed on and/or in at least the first subvolume of the semiconductor device as the at least one absorption and/or antireflection layer.

16. The method according to claim 11, wherein at least one dielectric antireflection layer is disposed on and/or in at least the first subvolume of the semiconductor device as the at least one absorption and/or antireflection layer.

17. A semiconductor device, comprising:
at least one region including a respective antiferromagnetic layer and a ferromagnetic layer with a magnetization of the ferromagnetic layer; and
at least one absorption and/or antireflection layer, on and/or in at least one subvolume of the semiconductor device which includes the at least region.

18. The semiconductor device according to claim 17, wherein at least a first partial area of a surface of at least the subvolume of the semiconductor device which includes the at least one region is covered with the at least one absorption and/or antireflection layer while at least a second partial area of the surface is not covered by the at least one absorption and/or antireflection layer.

19. The semiconductor device according to claim 17, wherein the at least one absorption and/or antireflection layer includes a silicon nitride layer, and/or a layer combination of at least one silicon nitride layer and at least one silicon oxide layer, and/or a titanium nitride layer, and/or a titanium tungsten nitride layer, and/or a tantalum layer, and/or a tantalum nitride layer, and/or a tungsten layer.

20. The semiconductor device according to claim 17, wherein the at least one absorption and/or antireflection layer includes at least one dielectric antireflection layer.
